(19) United States
(12) Patent Application Publication
(10) Pub. No.: US 2025/0062976 A1
(43) Pub. Date: Feb. 20, 2025

(54) WEB-BASED PLATFORMS FOR APPLYING GRAPH THEORY AND CRITICAL PATH METHODOLOGIES TO VALUE CHAIN MANAGEMENT WITH EVENT STREAMING PLATFORMS

(71) Applicant: JPMORGAN CHASE BANK, N.A., New York, NY (US)

(72) Inventors: Tyrone SAUNDERS, Houston, TX (US); Allen SIEMENS, Houston, TX (US); Christian Howard POST, Houston, TX (US); Austin DAUZAT, New Caney, TX (US)

(21) Appl. No.: 18/808,791

(22) Filed: Aug. 19, 2024

Related U.S. Application Data
(60) Provisional application No. 63/520,420, filed on Aug. 18, 2023.

(51) Int. Cl. H04L 43/08; H04L 41/06; H04L 41/16

(52) U.S. Cl. CPC H04L 43/08; H04L 41/06; H04L 41/16

(57) ABSTRACT

A method may include: receiving a value stream for a process comprising an identification of systems involved in the process and expected events in the process; receiving an event from an event streaming platform published by a system of a plurality of systems and comprises a system identifier for the system and a process identifier for a process; processing the event by comparing the event to the value stream; generating a new event based on the processing; publishing the new event to the event streaming platform, wherein the new event is consumed by the plurality of systems; generating metrics for the process; publishing the metrics to an alerting platform, wherein the alerting platform is configured to generate an alert in response to receiving certain metrics; and publishing the metrics to an automation platform, wherein the automation platform is configured to suggest an automation in response to receiving certain metrics.

### RELATED APPLICATIONS

This application claims priority to, and the benefit of, U.S. Provisional Patent Application Ser. No. 63/520,420, filed Aug. 18, 2023, the disclosure of which is hereby incorporated, by reference, in its entirety.

### BACKGROUND OF THE INVENTION

### 1. Field of the Invention

Embodiments are generally directed to web-based platforms for value chain management with event streaming platforms.

### 2. Description of the Related Art

Value chains represent the progression of activities that enable products or services. Value is added to the product at each activity step such that the product delivered to a customer (in the end) is the sum of the added values of each activity.

Data for value chains is often trapped in multiple places, which makes it difficult to run an efficient supply chain. Because of this, visualizing value chains, planning value chains, revising value chains, simulating value chains, and understanding the impacts of different events on a value chain's overall flow and timeliness is challenging. This may contribute to negative value chain phenomena such as the bullwhip effect, product shortages, cost overruns, and equipment/warehousing unavailability.

### SUMMARY OF THE INVENTION

Web-based platforms for value chain management with event streaming platforms are disclosed. According to an embodiment, a method may include: (1) receiving, by a computer program, a value stream for a process, wherein the value stream may include an identification of plurality of systems involved in the process and a plurality of expected events in the process; (2) receiving, by the computer program, an event from an event streaming platform, wherein the event was published by a system of a plurality of systems and may include a system identifier for the system and a process identifier for a process; (3) processing, by the computer program, the event by comparing the event to the value stream; (4) generating, by the computer program, a new event based on the processing; (5) publishing, by the computer program, the new event to the event streaming platform, wherein the new event may be consumed by the plurality of systems; (6) generating, by the computer program, metrics for the process; (7) publishing, by the computer program, the metrics to an alerting platform, wherein the alerting platform may be configured to generate an alert in response to receiving certain metrics; and (8) publishing, by the computer program, the metrics to an automation platform, wherein the automation platform may be configured to suggest an automation in response to receiving certain metrics.

In one embodiment, the process may include a manufacturing process, an information processing process, etc.

In one embodiment, the value stream may be received in formatted JSON, YAML, or XML documents.

In one embodiment, the method may also include: receiving, by computer program, policy information for an organization, wherein the computer program further processes the policy information with the events.

In one embodiment, the event may include an inventory event, a job event, an action event, and/or a system status event.

In one embodiment, the method may also include: periodically pinging, by the computer program, the systems for a system status.

In one embodiment, the processing calculates service metrics, state metrics, and capacity metrics for the plurality of systems.

In one embodiment, the alert may include an alert to order resources in response to the certain metric indicating low resource availability.

In one embodiment, the automation may include reducing time at a bottleneck step in response to the certain metric identifying a bottleneck in the process.

In one embodiment, the method may also include: generating, by the computer program, an insight based on the metrics using historical data by identifying an effectiveness of a decision on the historical data, wherein the insight may be based on the effectiveness. The computer program may train a machine learning model using the effectiveness as a reinforcement learning weight.

According to another embodiment, a system may include: an event streaming platform in communication with a plurality of systems; an alerting platform; an automation platform; and a value chain platform comprising a computer processor an executing a computer program that may be configured to receive a value stream for a process, wherein the value stream may include an identification of a plurality of the systems involved in the process and a plurality of expected events in the process; to receive an event from the event streaming platform, wherein the event was published by a system of the plurality of systems and may include a system identifier for the system and a process identifier for a process; to process the event by comparing the event to the value stream; to generate a new event based on the processing; to publish the new event to the event streaming platform, wherein the new event may be consumed by the plurality of systems; to generate metrics for the process; to publish the metrics to an alerting platform, wherein the alerting platform may be configured to generate an alert in response to receiving certain metrics; and to publish the metrics to an automation platform, wherein the automation platform may be configured to suggest an automation in response to receiving certain metrics.

In one embodiment, the process may include a manufacturing process or an information processing process.

In one embodiment, the computer program may be further configured to receive policy information for an organization and to further process the policy information with the events.

In one embodiment, the event may include an inventory event, a job event, an action event, and/or a system status event.

In one embodiment, the processing calculates service metrics, state metrics, and capacity metrics for the plurality of systems.

In one embodiment, the alert may include an alert to order resources in response to the certain metric indicating low resource availability.

In one embodiment, the automation may include reducing time at a bottleneck step in response to the certain metric identifying a bottleneck in the process.

In one embodiment, the computer program may be further configured to generate an insight based on the metrics using historical data by identifying an effectiveness of a decision on the historical data, wherein the insight may be based on the effectiveness and to train a machine learning model using the effectiveness as a reinforcement learning weight.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for value chain management with event streaming platforms according to an embodiment;

FIG. 2 illustrates a method for value chain management with event streaming platforms according to an embodiment; and

FIG. 3 depicts an exemplary computing system for implementing aspects of the present disclosure.

### DETAILED DESCRIPTION OF PREFERRED EMBODIMENTS

Embodiments are generally directed to systems and methods for value chain management with event streaming platforms according to an embodiment.

Embodiments may include a platform that may interface with an event streaming platform that allows systems to publish value chain stage events for consumption by systems and clients. Embodiments may further leverage graph theory and critical path methodologies to generate insights into the status of all the stages of a value chain, earliest and latest start and finish times of stages, where slack lies in a value chain and what stages are on the critical path of the value chain, etc. Embodiments may also include user interfaces that allow for configuration of the graph-based value chain and for querying the value chain for analysis and trends.

Embodiments may provide at least some of the following: the use of graph theory to define a value stream; the use of graph theory/network science to determine critical path; the use of graph theory/network science to determine node times like earliest start/finish, latest start/finish, total slack time, free slack time; a user interface to design value stream stages and time required to complete a stage on to a graph by defining stage pre-requisites, and the ability to connect individual stages on a value stream with event streaming platform topics.

In embodiments, inventory may be measured differently at different levels, and may be accounted for at the physical, the virtual and the “as a service” layers. Hardware fungibility may ensure that limited (and costly) physical resources are applied to the cloud elements just in time. Resource counting from cloud architectural elements down to the physical components may vary with implementation and with standards and policies. The counting control and action for these resources may be adapted to the cloud delivery for the parameters set by the business or organization.

When physical infrastructure is placed into a workflow for inventory pools of physical infrastructure, standards may be applied to determine the ratio conversion to virtual infrastructure. The resulting virtual infrastructure may be placed into a workflow as an inventory pool.

Policies may determine a balance between the physical and the virtual, which may drive automation to signal updates to standards and policies to decommission or build more virtual or physical infrastructure into the supply chain.

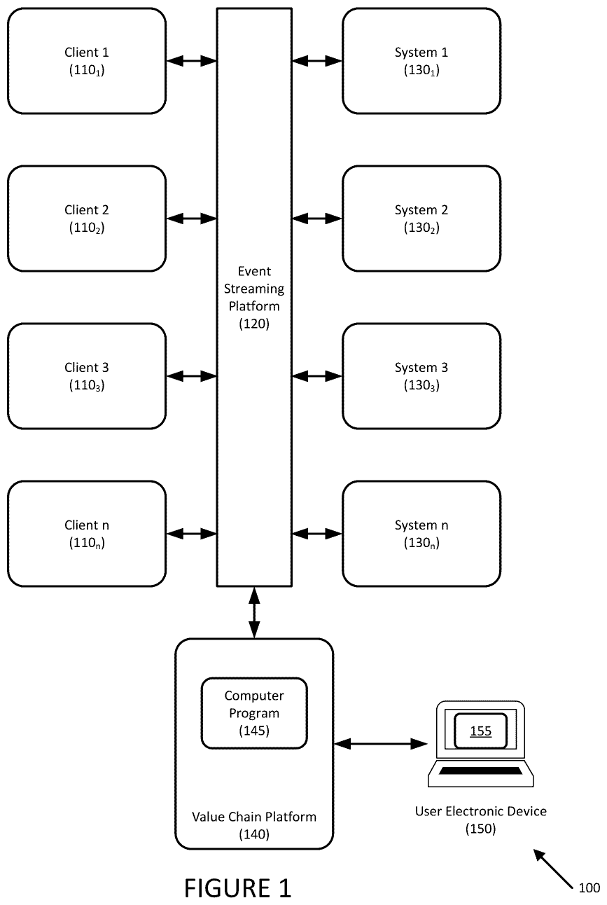

Referring to FIG. 1, a system for value chain management with event streaming platforms is disclosed according to an embodiment. System 100 may include a plurality of clients 110 (e.g., client 110₁, client 110₂, client 110₃, . . . client 110ₙ) that may communicate with event streaming platform 120. Clients may be consumers of goods, services, or information provided by event streaming platform.

System 100 may also include a plurality of systems 130 (e.g., system 130₁, system 130₂, system 130₃, . . . system 130ₙ) that may perform a task (e.g., a manufacturing task for a widget, an information processing task, a service, etc.) Systems 130 may also consume information from event streaming platform 120. Systems 130 may include elements in a supply chain, such as applications, Internet of Things (IoT) devices, bar-code/radio frequency identifier readers, mobile electronic devices, scripts, micro-services, Enterprise Resource Planning (ERP) systems, etc.

In embodiments, both clients 110 and systems 130 may consume and produce data and events. For example, systems 130 may provide physical inventory, process updates, etc. Systems 130 may also receive events and consume the events, which may control how systems 130 perform.

System 100 may also include value chain platform 140 that may execute computer program 145 that may monitor event streaming platform 120 and may apply graph theory to the events. For example, computer program 145 may receive demand average, lead time average, service level, demand variability, lead time variability, etc.

Computer program 145 may also derive and output insights, such as any bottlenecks in the flow of a process through clients 110 and/or systems 130, may provide notifications, etc. to user interface 155 that may be executed by user electronic device 150.

For example, computer program 145 may identify reorder points for reordering raw materials, supplies, hardware, etc. for systems 130 based on the inputs. In one embodiment, computer program 145 may identify the optimal reordering points based on, for example, current inventory, lead time, production rates, etc.

In one embodiment, computer program 145 may execute self-healing actions, such as revising the flow through one or more of clients 110 and/or systems 130. Computer program 145 may also identify patterns using, for example, artificial intelligence (AI), machine learning, etc. Thus, embodiments may take proactive steps, such as being able to foresee failure events before they happen. An example of such is identifying a potential breakdown from an increasing cycle time.

Computer program 145 may also use graph theory to define a value stream, to determine critical path(s), to determine node times (e.g., earliest start/finish, latest start/finish, total slack time, free slack time), etc.

User interface 155 may allow a user to input design value stream stages and time required to complete a stage on to a graph by defining pre-requisite for the stages and/or systems in the stream. User interface 155 may be a web or mobile based user interface with corresponding Application Programming Interface (API) that allows users to build filters on data stored in a data lake/database to define the widget (product type or process) that traverses stages of a value stream. The filters may be built by defining operands on attributes of things in the data lake. An example of a filter query is: Attribute A is equal to X AND Attribute B is greater than Y AND Attribute C is not null.

In embodiments, natural language queries may also be used.

Computer program 145 may also use AI to learn and gauge the complexity of a job or process. For example, computer program 145 may monitor the identity, learning time, work time, rates, touches, etc. for a job or process, and may update the complexity of the job or process.

Embodiments may connect individual stages on a value stream with event streaming platform topics.

Event streaming platform 120 may be used to track the completion of value stream stages. Events on event streaming platform 120 may be linked to widgets via, for example, a correlation identifier. Event payloads on event streaming platform 120 may include a completion date/time and the correlation identifier.

Event streaming platform 120 may use, for example, a publisher/subscriber architecture (e.g., Kafka, RabbitMQ, or REST API calls), and may send messages based on a received input/action to, for example, a system (not shown) that is open to receiving messages to then perform additional actions based on the messages.

Clients 110 may subscribe to receive messages from event streaming platform 120 using a web or mobile based user interface and a corresponding API that allows for configuration of the consumption of topics from an event streaming platform into an application. The configuration may allow associating event streaming platform topics to value stream stages.

Event streaming platform 120 may provide additional technical features, such as security, resiliency, etc. For example, event streaming platform 120 may identify when certain systems 130 go offline or are no longer in operation and may identify when they are later restored. Event streaming platform 120 may then receive any data that was generated by the system 130 while it was offline and may calculate any metrics/actions on the newly received data. For example, a factory's internet connection may go down for an hour. Once the connection is restored, event streaming platform 120 or other components may recognize it is back online and may receive any data that was generated while it was offline. It may then recalculate metrics, such as cycle time.

In embodiments, each system 130 may have its own functional account. Embodiments may use password-less authentication systems, such as Kerberos.

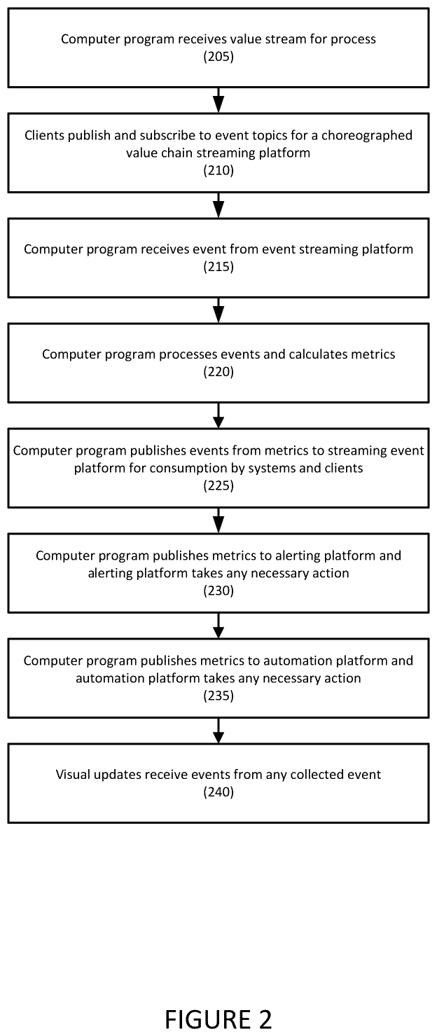

Referring to FIG. 2, a method for value chain management with event streaming platforms is disclosed according to an embodiment is provided according to an embodiment.

In step 205, computer program executed by a value chain platform may receive a value stream for a process. In one embodiment, the value stream may include a plurality of systems that may be involved in the process, and a plurality of expected events that are expected to be performed by the systems in performance of the process.

In one embodiment, a value stream may be defined from user input into a computer program through graphical user interface or by uploading formatted JSON, YAML, or XML documents. Upon value stream definition, a unique identifier for that value stream may be generated. Events may then be matched to inventory matching that value stream in order to capture a picture of the state changes of the value stream for a specific inventory member of an inventory pool.

In one embodiment, the computer program may also receive policy information for an organization, such as a desired number of widgets to produce, an amount of raw materials/resources to have on hand, etc.

In step 210, clients and systems may publish and subscribe to events from an event streaming platform. For example, the clients and systems may subscribe to the event streaming platform using a web or mobile based user interface and a corresponding API that allows an individual to configure the consumption of topics from an event streaming platform into an application. The configuration may allow associating event streaming platform topics to value stream stages.

In step 215, the computer program may receive events from the event streaming platform. For example, the computer program may receive such as inventory events (e.g., low inventory, correct inventory, too much inventory, etc.), job events (e.g., early, on schedule, late), action events (e.g., widget x installed into widget y, widget x machined by machine a without defect, process z has begun on widget x and will be completed by y time, etc.) status events (e.g., on-line, off-line, etc.), etc. from the clients and/or systems.

In one embodiment, each event may include a timestamp, and one or more identifiers (e.g., a client or system identifier, a process identifier (e.g., for the entire process), a task identifier (e.g., for a task that is part of process)), etc.

In one embodiment, a control/plane system on site may periodically ping each system for the health of the systems. If no response is received, the system may be listed as off-line, as unhealthy etc. This information may be used to update the timing, update reorder points, to re-route a process, etc.

As another example, the health may be manually entered by operators.

In step 220, the computer program may process the events and may calculate service metrics (e.g., time, value, etc.) for the system, may calculate state metrics (e.g., stage/location of production, production activity, etc.), may calculate capacity metrics (e.g., inventory available, etc.). For example, the computer program may consume metrics and applies rules based on network process definitions and country, regulatory, company, division, and team policies.

The identifiers may be used to calculate, for example, a status or state of the task or process, etc. by comparing the system and events to the value stream definition. For example, the computer program may compare an expected event, system, etc. to the event received, and may determine whether the process is proceeding as expected.

In one embodiment the identifiers may be used to chain or link various pieces of information together and may be used to query information related to the identifier. For example, a query with an identifier for a process may yield all events, actions, systems, etc. that may be involved with the identifier. As another example, a query for an identifier for a system may return all events associated with that system, and may be used to determine metrics such as first pass yield, efficiency etc. These calculations may be used to preferentially route as many processes as possible through a specific machine since it has the lowest defect rate.

In one embodiment, once published to the event streaming platform, the events may be consumed by clients, systems, etc. For example, a device moving along the stream may influence the average cycle time of all of the devices measured. The metrics may then be calculated in real-time.

Embodiments may identify bottlenecks which may be used to enable automation actions to mitigate those bottlenecks.

The computer program may also use graph theory (e.g., the analysis of relationships between systems and/or events) to define a value stream, to determine critical path(s), to determine node times (e.g., earliest start/finish, latest start/finish, total slack time, free slack time), etc.

In one embodiment, the computer program may provide insights and/or notifications. For example, the computer program may also derive and output insights, such as any bottlenecks in the flow of a job through the system, may provide notifications, etc. In one embodiment, the computer program may take self-healing actions, such as revising the flow through the systems.

In one embodiment, the computer program may apply artificial intelligence to the metrics to generate the insights. For example, the computer program may collect historical data based on inventory, standards, or routing decisions, and may identify patterns from this historical data. For example, the historical data may identify times of high demand, reduced productivity, system failures, etc.

From the historical data, patterns, and decisions, the computer program may determine an effectiveness of decision changes and patterns on the metrics and may use the effectiveness as reinforcement learning criteria weights.

The computer program may apply this learning to events as they are received from the event streaming platform.

In one embodiment, the computer program may calculate optimal reordering points based on the events.

In step 225, the computer program may publish new events generated as a result of the metrics to the event streaming platform, where the events may be consumed by the clients and/or systems. For example, the computer program may identify an expected event from one of the systems that was not received. The computer program may then publish as missed event to the streaming platform and to other systems. In response, an alerting platform may generate an alert, and an automation platform may take a corrective action, such as routing the process or event to a different system.

As another example, in response to an error identified from the metrics (e.g., an unsatisfactory product or service, incorrectly performed task, etc.), the computer program may calculate an error rate, and may publish an event to the streaming event platform and downstream systems. In response, the alerting platform may generate an alert, and an automation platform may take a corrective action. For example, some errors may be caused by an event being initiated without all needed information, or with incorrect information. The corrective action may be for the computer program to return an error, and the original system in the process may identify, and may reinitiate the event.

As another example, if defect rates start climbing for a particular system, a corrective action may be to trigger maintenance or investigation, and, if possible, re-routing to reduce load to this system until the investigation/maintenance is complete.

In embodiments, the computer program may learn from the events what a steady state for all systems involves and may use that learning to achieve a steady state. For example, the computer program may learn the characteristics of a steady state system from historical data and may control individual systems to achieve equilibrium. As an illustrative example, the computer program may learn not to order more than 40% of raw materials from a single supplier in order to mitigate the risk associated with a single supplier.

As another illustrative example, the computer program may learn that an individual systems' defect rate increases if it is not maintained every five days. Thus, the computer program may schedule maintenance on the individual system as required.

As still another illustrative example, the computer program may identify an increase in defects from an individual's station on Wednesday afternoons. This may be due to, for example, the employee rushing to leave at a certain time. The computer program may recommend that the process be re-routed so as to reduce this risk.

In step 230, the computer program may publish the service metrics, the state metrics, and/or the capacity metrics to an alerting platform, which may generate alerts from the metrics and insights. For example, if a system is not operating, the alerting platform may generate an alert to have the system evaluated. If resources are low, the alerting platform may generate an alert to order resources.

For example, if a significant defect rate is detected, the alerting platform may generate an alert for the manager that a shutdown may be needed. If the shipment of materials is delayed, the alerting platform may generate and send an alert to the systems at a facility, or to managers, with suggestions such as to reduce staffing, reprioritize production, etc. If a material ordered seems to have resulted in abnormally high defect rate of products, the alerting platform may send a notification to a manager to investigate the supplier.

In step 235, the computer program may publish the service metrics, the state metrics, and/or the capacity metrics to an automation platform, which may identify process that may be automated. This may be performed for level loading. For example, the automation platform may identify long process times for a step in a process that is a bottleneck and may suggest reducing the time of the bottleneck step. As another example, the automation platform may identify a bottleneck due to resource constraints and may recommend adding additional resources to alleviate the bottleneck.

In step 240, the metrics and/or insights may be presented visually to a user. For example, the metrics may be presented graphically on, for example, a production dashboard. Financial revenue numbers, inventory quantity over time, sales projections, cost/benefit analysis of path A versus path B, etc., may also be presented.

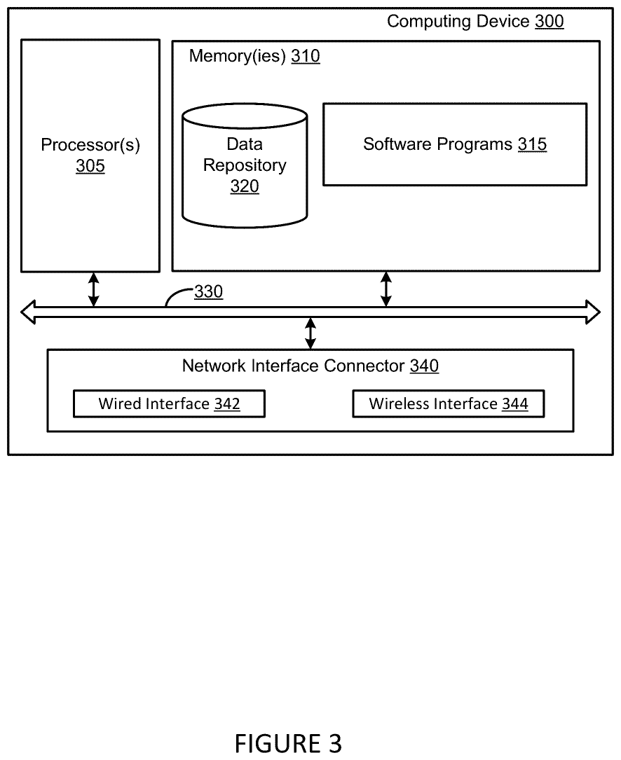

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

The disclosure of U.S. patent application Ser. No. 17/929,276 is hereby incorporated, by reference, in its entirety.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program, a value stream for a process, wherein the value stream comprises an identification of a plurality of systems involved in the process and a plurality of expected events in the process;
receiving, by the computer program, an event from an event streaming platform, wherein the event was published by a system of a plurality of systems and comprises a system identifier for the system and a process identifier for a process;
processing, by the computer program, the event by comparing the event to the value stream;
generating, by the computer program, a new event based on the processing;
publishing, by the computer program, the new event to the event streaming platform, wherein the new event is consumed by the plurality of systems;
generating, by the computer program, metrics for the process;
publishing, by the computer program, the metrics to an alerting platform, wherein the alerting platform is configured to generate an alert in response to receiving certain metrics; and
publishing, by the computer program, the metrics to an automation platform, wherein the automation platform is configured to suggest an automation in response to receiving certain metrics.

2. The method of claim 1, wherein the process comprises a manufacturing process.

3. The method of claim 1, wherein the process comprises an information processing process.

4. The method of claim 1, the value stream is received in formatted JSON, YAML, or XML documents.

5. The method of claim 1, further comprising:
receiving, by computer program, policy information for an organization, wherein the computer program further processes the policy information with the events.

6. The method of claim 1, wherein the event comprises an inventory event, a job event, an action event, and/or a system status event.

7. The method of claim 1, further comprising:
periodically pinging, by the computer program, the systems for a system status.

8. The method of claim 1, wherein the processing calculates service metrics, state metrics, and capacity metrics for the plurality of systems.

9. The method of claim 1, wherein the alert comprises an alert to order resources in response to the certain metric indicating low resource availability.

10. The method of claim 1, wherein the automation comprises reducing time at a bottleneck step in response to the certain metric identifying a bottleneck in the process.

11. The method of claim 1, further comprising:
generating, by the computer program, an insight based on the metrics using historical data by identifying an effectiveness of a decision on the historical data, wherein the insight is based on the effectiveness.

12. The method of claim 11, further comprising:
training, by the computer program, a machine learning model using the effectiveness as a reinforcement learning weight.

13. A system, comprising:
an event streaming platform in communication with a plurality of systems;
an alerting platform;
an automation platform; and
a value chain platform comprising a computer processor an executing a computer program that is configured to receive a value stream for a process, wherein the value stream comprises an identification of a plurality of the systems involved in the process and a plurality of expected events in the process; to receive an event from the event streaming platform, wherein the event was published by a system of the plurality of systems and comprises a system identifier for the system and a process identifier for a process; to process the event by comparing the event to the value stream; to generate a new event based on the processing; to publish the new event to the event streaming platform, wherein the new event is consumed by the plurality of systems; to generate metrics for the process; to publish the metrics to an alerting platform, wherein the alerting platform is configured to generate an alert in response to receiving certain metrics; and to publish the metrics to an automation platform, wherein the automation platform is configured to suggest an automation in response to receiving certain metrics.

14. The system of claim 13, wherein the process comprises a manufacturing process or an information processing process.

15. The system of claim 13, wherein the computer program is further configured to receive policy information for an organization and to further process the policy information with the events.

16. The system of claim 13, wherein the event comprises an inventory event, a job event, an action event, and/or a system status event.

17. The system of claim 13, wherein the processing calculates service metrics, state metrics, and capacity metrics for the plurality of systems.

18. The system of claim 13, wherein the alert comprises an alert to order resources in response to the certain metric indicating low resource availability.

19. The system of claim 13, wherein the automation comprises reducing time at a bottleneck step in response to the certain metric identifying a bottleneck in the process.

20. The system of claim 13, wherein the computer program is further configured to generate an insight based on the metrics using historical data by identifying an effectiveness of a decision on the historical data, wherein the insight is based on the effectiveness and to train a machine learning model using the effectiveness as a reinforcement learning weight.
